(19) United States
(12) Patent Application Publication
(10) Pub. No.: US 2016/0077675 A1
(43) Pub. Date: Mar. 17, 2016

(54) METHOD AND A MOBILE DEVICE FOR AUTOMATIC SELECTION OF FOOTAGE FOR ENRICHING THE LOCK-SCREEN DISPLAY

(71) Applicant: MAGISTO LTD., Nes-Ziona (IL)

(72) Inventors: Alexander RAV-ACHA, Rehovot (IL); Oren BOIMAN, Sunnyvale, CA (US)

(21) Appl. No.: 14/855,625

(22) Filed: Sep. 16, 2015

Related U.S. Application Data
(60) Provisional application No. 62/050,791, filed on Sep. 16, 2014.

(51) Int. Cl. G06F 3/0481; G06T 1/00; H04M 1/725

(52) U.S. Cl. CPC G06F 3/0481; H04M 1/72544; G06T 1/0007

(57) ABSTRACT

A method and a mobile device for automatic selection of footage for enriching the lock-screen display are provided herein. The method may include the following steps: maintaining a plurality of captured media entities on a mobile device; obtaining, in real-time, at least one device parameter indicative of at least one of: a context, a location, and a time period in which the mobile device operates, responsive to a transit to a lock screen mode of the mobile device; automatically selecting a subset of the plurality of the captured media entities, based on the at least one device parameter; and presenting at least some of the selected subset of the captured media entities on a display unit of the mobile device. The mobile device implements the aforementioned method.

### CROSS REFERENCE TO RELATED APPLICATIONS

This application claims the benefit of U.S. Provisional Patent Application No. 62/050,791, filed on Sep. 16, 2014, which is incorporated herein by reference in its entirety.

### FIELD OF THE INVENTION

The present invention relates generally to the field of video production, and more particularly to video production carried out on mobile devices.

### BACKGROUND OF THE INVENTION

Prior to setting forth the background of the invention, it may be helpful to set forth definitions of certain terms that will be used hereinafter.

The term ‘mobile device’ as used herein is broadly defined as any portable (having its own power source) computing platform than includes a display and may further include a capturing device and connectivity over a network.

The term ‘media entities’ as used herein is broadly defined as images, or video footage or audio or any combination thereof.

The term ‘video clip’ as used herein is broadly defined as a combination of subsets of media entities embedded with video effects (graphical effects) and transitions and is a part of a domain called in general video production.

The term ‘lock-screen display’ is a mode of many electronic devices that include a display. In such a mode, the screen is locked after a certain time has lapsed without any activity. Usually there is a simple movement (in case of a touch screen) or a code that needs to be entered so the screen becomes active again.

The lock-screen display is an important screen as it is viewed very frequently by the user. Today, as the number of smartphones and tablets increases dramatically, the lock-screen is viewed by billions of people every day.

The common lock-screen display today includes an image wallpaper or random photo slideshow (together with some information such as time, date, notifications, and the like). This display can be enriched by showing to the user a selected subset of its photos and videos. Today, as most smartphones (and many other devices like tablets) are also used as cameras, most users have a large set of photos and videos in their camera roll.

It would, therefore, be advantageous to enrich the lock-screen display with the user's own photos and videos.

### SUMMARY OF THE INVENTION

Some embodiments of the present invention provide a method and a mobile device for automatic selection of footage for enriching the lock-screen display. The method may include the following steps: maintaining a plurality of captured media entities on a mobile device; obtaining, in real-time, at least one device parameter indicative of at least one of: a context, a location, and a time period in which the mobile device operates, responsive to a transit to a lock screen mode of the mobile device; automatically selecting a subset of the plurality of the captured media entities, based on the at least one device parameter; and presenting at least some of the selected subset of the captured media entities on a display unit of the mobile device. The mobile device implements the aforementioned method

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architectures of a system in accordance with some embodiments of the present invention; and

FIG. 2 is a high level flowchart illustrating non-limiting exemplary method in accordance with some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Some embodiments of the present invention will illustrate below how footage stored on mobile devices such as smartphones can be used as a pool from which it will be possible to automatically select the best subset to be displayed to the user as part of its lock-screen.

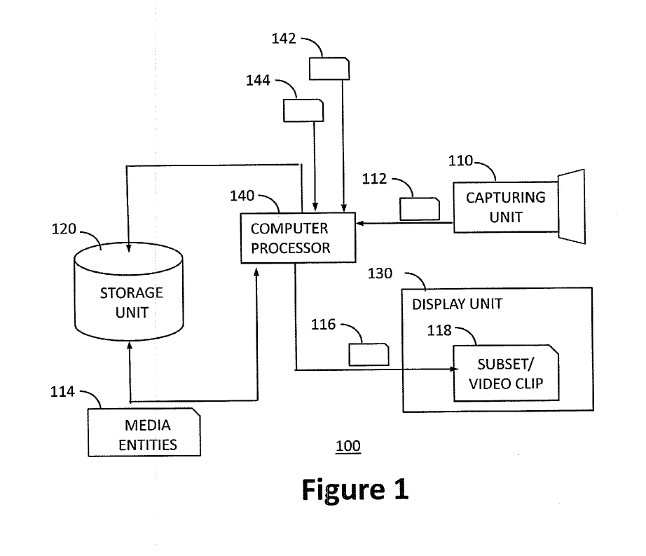

FIG. 1 is a block diagram illustrating an exemplary architecture on which some embodiments of the present invention may be implemented. A mobile device 100 may include a capturing unit 110 configured to capture media entities 112, a storage unit 120 configured to maintain a plurality of media entities 114 (which may also include media entities not originated by capturing unit 110). Mobile device 100 may also include display unit 130.

Additionally, mobile device 100 may include a computer processor 140 configured to obtain, in real-time, at least one device parameter 142 indicative of at least one of: a context, a location, and a time period in which mobile device 100 operates, responsive to a transit to a lock screen mode of mobile device 100.

Computer processor 140 may be further configured to automatically select a subset 116 of the plurality of the captured media entities, based on the at least one device parameter 142. Computer processor 140 may be further configured to present at least some of the selected subset 116 of the captured media entities 114 on display unit 130 of mobile device 100.

According to some embodiments of the present invention, computer processor 140 may be further configured to generate a video clip 118, based on the selected subset 116 of the plurality of the captured media entities 114, wherein presenting the at least some of the selected subset of the plurality of the captured media entities comprises presenting the video clip.

According to some embodiments of the present invention, the generated video clip may include at least one graphical effect or transition, and wherein the graphical effect or transition corresponds to the at least one device parameter.

According to some embodiments of the present invention, the generating of a video clip can be performed by editing and applying visual effects to the selected footage. Some examples are:

Single video production—in this embodiment there will be adding visual effects to a single image, which can take into account its visual content. Examples for such effects are zooming to an important object in the photo (e.g., a person), adding decoration around an important object or blurring the surrounding of this important object, and the like (e.g., by using face detection and recognition which can be used to define such important objects). These visual effects might be dynamic, thereby creating an animation. The animation may start when the lock screen is activated, or it might be applied in response to the movement of the device thereafter.

Video editing and production—in this embodiment there will be joining together multiple video portions and/or photos, to create an edited video. Video editing can be used for both photos and videos. A simple example for production effect that is aimed to a sequence of photos is stop-motion effect: displaying a sequence of photos that are similar but not identical (for example, has a small motion between them). This effect can also be applied on multiple photos that where sampled from the same video. In this example, the transition between the different photos can be done in response to the movement of the device (e.g., a tilt), which makes it feel as if the animation interacts with the user actions.

According to some embodiments of the present invention, editing and production of the video clip maybe done off-line, for example, once a day or when the mobile device is connected to the internet (in which case, the produced media is stored), or it can be added in real-time on the mobile device when the user activates the lock-screen display.

Following below are a plurality of non-limiting exemplary criteria for automatically selecting the footage or media entities to be shown on the lock screen. Obviously, the lock-screen screen display should be dynamic, and therefore, different selections may be used at different times and occasions:

Footage quality—the quality of each image or video can be estimated using various methods know in the art—for example, estimating its noise level or blur level, or content-based quality which also base the quality score on the objects appearing in the footage, for example—favoring photos with faces.

Video editing criteria. The footage can also be selected based on video editing criteria. In this case, the selection doesn't rely merely on the independent quality of each photo or video, but selects the footage that best “tells a story”, for example, favoring a selection of a set of photos that corresponds to the same event, rather than selecting a random set of un-related high quality photos. In addition, this mechanism can decide to select portions of footage, for example, periods of videos or sub-regions of photos. Assuming that a few photos or videos were selected as a single “event”, they can be played consecutively in the lock-screen display (for example, as a slide-show or as an edited video).

The footage quality score can also be based on a combined analysis of the user's footage and external information, learning, for example, who are the user's friends, family, habits, and the like. For example, the main characters in a user's footage can be recognized using face detection and indexing algorithms, and the faces that appear most frequently are the most important. As a result, photos and videos that include these important characters and/or faces will get higher score and will be more likely to be selected.

Using time of day and/or date—the time of day can be used as a parameter for the footage selection and production. Some examples are:

Selecting footage that was shot in the evening to be display in the evening, and day light footage to be displayed in the day-light.

Using a calm editing style or production effects for lock-screen displays that are shown in the evening time (and correspondingly other styles for others parts of the day).

Choosing footage whose date has some relation to the current date, e.g., footage taken in the last day, footage taken in approximately the same hour in other days, footage taken a year ago, and the like.

The selected footage may be a summary of a certain period, e.g., summary of the day or month or year.

User rating history of the lock screen—a rating mechanism can be added to the screen-lock display, which allows the user to give a score to the automatic selection, and enables to automatically learn the selection parameters based on the user preferences. A simple rating mechanism is a like/unlike button.

User preferences—the user may be able to manually control the selection & production parameters for the lock screen, for example preferring a specific type of content, production style, frequency of changes in the selection, or simply enabling or disabling some of the features (the extreme case—simply choosing to use the traditional lock-screen display).

Selection based on user actions—the history of user actions can be very informative for selecting the footage for the user.

Favoring footage that the user has liked (currently there are various mechanism in which the user given indications on the footage quality, e.g., ‘likes’ in applications such as Facebook, video ratings, and the like).

Favoring footage that was viewed more frequently (assuming that the number of views is kept for each asset), or most recently.

Favoring footage that was shared (which is an indirect indication that this footage is good or important to the user).

According to some embodiments of the present invention, the generated clips, displayed movies or photos may be in the form of preview versions of edited videos. In this case, these previews might be attached with a link to the full version (so that if the user likes the preview, he can directly open the full video in a single click).

According to some embodiments of the present invention, usage of photos and videos for enriching the lock-screen display may involve some power-saving considerations, in order to avoid consuming too much buttery power. In addition, we would like to synchronize the dynamics (video playing and animations) to the moments where the user's attention is maximal.

One implementation may include applying play/pause of the video or the visual effects in response to gaze detection (i.e., the animation will be played only at moments when the gaze detection indicates that the user is actually looking at the screen). There are various known methods for gaze detection that can be used, and are all known in the art.

Another example for responding to external information and actions is revealing the ‘unlock’ UI in response the user action, for example, after detection a finger that is approaching the screen (This functionality also exist in some devices, based, e.g., on IR or on stereo analysis). This mechanism enables a display of videos and photos with no ‘disturbance’ of unnecessary UI components.

According to other embodiments of the present invention, computer processor 140 may be further configured to derive from the obtained at least one device parameter, a state of a user that is associated with the mobile device. Additionally, the automatically selecting a subset of the plurality of the captured media entities will be further based on the derived state of the user.

According to some embodiments of the present invention, the context of the mobile device may be derived by computer processor 140 by analyzing at least one of: a history of actions carried by a user of the mobile device, and a list of applications available that were used or visited by the user of the mobile device.

According to some embodiments of the present invention, the context of mobile device 100 may be derived by computer processor 140 by analyzing movements of mobile device 100 based on measurements of sensors 150 of mobile device 100, thereby deducing at least one of: posture, gesture, and mobility of a user of mobile device 100, and thereby the use that is holding it.

According to some embodiments of the present invention, the context may be obtained by accessing a calendar stored on the mobile device indicating events. Such events can be, for example, a sporting event or a tournament, and in this case the selection can be of previous sporting events to be shown as part of the video clip. It can be a family gathering, and so members of the family will be used as important objects to trace and selected as the subset of media entities.

According to some embodiments of the present invention, the plurality of the captured media entities 114 was captured by the capturing device 110 of mobile device 100.

According to some embodiments of the present invention, computer processor 140 may be further configured to derive from the obtained at least one device parameter 142, a state 144 of a user that is associated with the mobile device, wherein the graphical effect or transition is based on the derived state of the user. Thus, the transitions can reflect the mood of the user or try to address it in various manners. A calm mood can cause the transitions to be of a slow pace or using peaceful video effects.

According to some embodiments of the present invention, state 144 of the user comprises at least one of: mood of the user, state of mind of the user, and emotional state of the user. Similarly, weather can be also a state that may be reflected by the type of video effects used.

According to some embodiments of the present invention, state 144 of the user comprises at least one of: user is out of home; user is out of office, and user is traveling.

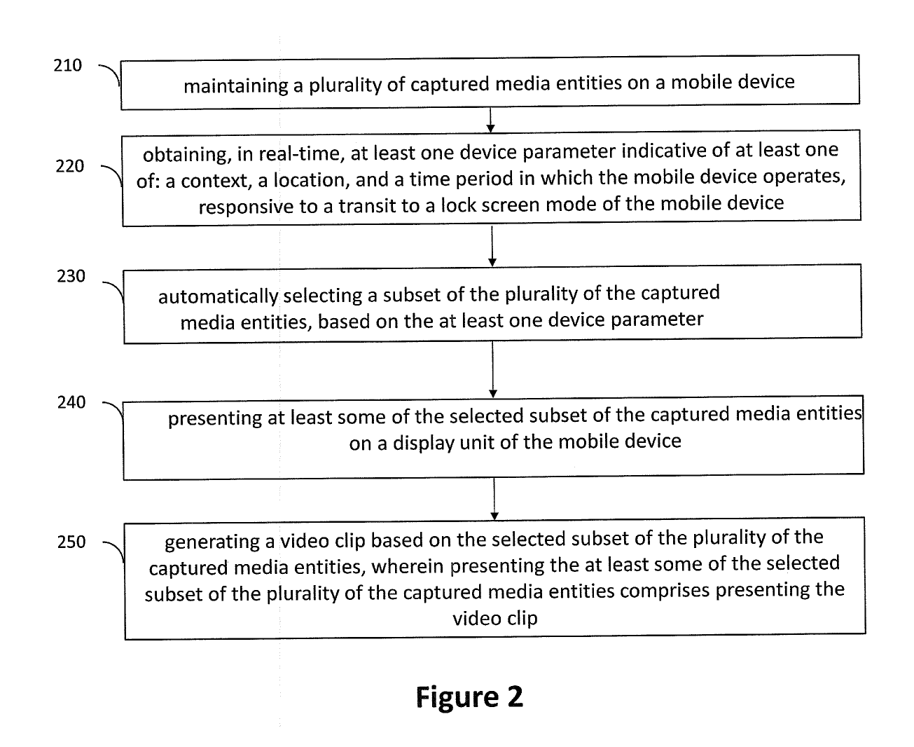

FIG. 2 is a flowchart diagram illustrating a method implementing some embodiments of the invention, without necessarily being tied to the aforementioned architecture of mobile device 100. Method 200 may include the following steps: maintaining a plurality of captured media entities on a mobile device 210; obtaining, in real-time, at least one device parameter indicative of at least one of: a context, a location, and a time period in which the mobile device operates, responsive to a transit to a lock screen mode of the mobile device 220; automatically selecting a subset of the plurality of the captured media entities, based on the at least one device parameter 230; and presenting at least some of the selected subset of the captured media entities on a display unit of the mobile device 240.

According to some embodiments of the present invention, method 200 may further include the step of generating a video clip based on the selected subset of the plurality of the captured media entities, wherein presenting the at least some of the selected subset of the plurality of the captured media entities comprises presenting the video clip 250.

According to some embodiments of the present invention, method 200 may further include the step of deriving from the obtained at least one device parameter, a state of a user that is associated with the mobile device, wherein the automatically selecting a subset of the plurality of the captured media entities, is further based on the derived state of the user.

According to some embodiments of the present invention, method 200 may further include the step of deriving from the obtained at least one device parameter, a state of a user that is associated with the mobile device, wherein the graphical effect or transition is based on the derived state of the user.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not o be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
maintaining a plurality of captured media entities on a mobile device;
obtaining, in real-time, at least one device parameter indicative of at least one of: a context, a location, and a time period in which the mobile device operates, responsive to a transit to a lock screen mode of the mobile device;
automatically selecting a subset of the plurality of the captured media entities, based on the at least one device parameter; and
presenting at least some of the selected subset of the captured media entities on a display unit of the mobile device.

2. The method according to claim 1, further comprising generating a video clip based on the selected subset of the plurality of the captured media entities, wherein presenting the at least some of the selected subset of the plurality of the captured media entities comprises presenting the video clip.

3. The method according to claim 2, wherein the generated video clip comprises at least one graphical effect or transition, and wherein the graphical effect or transition corresponds to the at least one device parameter.

4. The method according to claim 1, wherein said time period comprises one of: a day in a week, an hour in the day, and a day in a year.

5. The method according to claim 1, further comprising deriving from the obtained at least one device parameter, a state of a user that is associated with the mobile device, wherein the automatically selecting a subset of the plurality of the captured media entities, is further based on the derived state of the user.

6. The method according to claim 1, wherein the context of the mobile device is derived by analyzing at least one of: a history of actions carried by a user of the mobile device, and a list of applications available that were used or visited by the user of the mobile device.

7. The method according to claim 1, wherein the context of the mobile device is derived by analyzing movements of the mobile device based on measurements of sensors of the mobile device, thereby deducing at least one of: posture, gesture, and mobility of a user of the mobile device.

8. The method according to claim 1, wherein the context is obtained by accessing a calendar stored on the mobile device indicating events.

9. The method according to claim 1, wherein the plurality of the captured media entities were captured by the mobile device.

10. The method according to claim 3, further comprising deriving from the obtained at least one device parameter, a state of a user that is associated with the mobile device, wherein the graphical effect or transition is based on the derived state of the user.

11. The method according to claim 5, wherein the state of the user comprises at least one of: mood of the user, state of mind of the user, and emotional state of the user.

12. The method according to claim 5, wherein the state of the user comprises at least one of: user is out of home; user is out of office, and user is traveling.

13. A mobile device comprising:
a capturing unit configured to capture media entities;
a storage unit configured to maintain a plurality of media entities;
a display unit; and
a computer processor configured to:
obtain, in real-time, at least one device parameter indicative of at least one of: a context, a location, and a time period in which the mobile device operates, responsive to a transit to a lock screen mode of the mobile device;
automatically select a subset of the plurality of the captured media entities, based on the at least one device parameter; and
present at least some of the selected subset of the captured media entities on the display unit of the mobile device.

14. The mobile device according to claim 13, wherein the computer processor is further configured to generate a video clip based on the selected subset of the plurality of the captured media entities, wherein presenting the at least some of the selected subset of the plurality of the captured media entities comprises presenting the video clip.

15. The mobile device according to claim 14, wherein the generated video clip comprises at least one graphical effect or transition, and wherein the graphical effect or transition corresponds to the at least one device parameter.

16. The mobile device according to claim 13, wherein said time period comprises one of: a day in a week, an hour in the day, and a day in a year.

17. The mobile device according to claim 13, wherein the computer processor is further configured to derive from the obtained at least one device parameter, a state of a user that is associated with the mobile device, wherein the automatically selecting a subset of the plurality of the captured media entities, is further based on the derived state of the user.

18. The mobile device according to claim 13, wherein the context of the mobile device is derived by the computer processor by analyzing at least one of: a history of actions carried by a user of the mobile device, and a list of applications available that were used or visited by the user of the mobile device.

19. The mobile device according to claim 13, wherein the context of the mobile device is derived by the computer processor by analyzing movements of the mobile device based on measurements of sensors of the mobile device, thereby deducing at least one of: posture, gesture, and mobility of a user of the mobile device.

20. The mobile device according to claim 13, wherein the context is obtained by accessing a calendar stored on the mobile device indicating events.

21. The mobile device according to claim 13, wherein the plurality of the captured media entities were captured by the mobile device.

22. The mobile device according to claim 15, further comprising deriving from the obtained at least one device parameter, a state of a user that is associated with the mobile device, wherein the graphical effect or transition is based on the derived state of the user.

23. The mobile device according to claim 17, wherein the state of the user comprises at least one of: mood of the user, state of mind of the user, and emotional state of the user.

24. The mobile device according to claim 17, wherein the state of the user comprises at least one of: user is out of home; user is out of office, and user is traveling.
